(19) United States
(12) Patent Application Publication
(10) Pub. No.: US 2025/0098012 A1
(43) Pub. Date: Mar. 20, 2025

(54) METHODS AND APPARATUSES FOR TIMERS AND BEHAVIOR IN L2 U2N RELAY CASE

(71) Applicant: LENOVO (BEIJING) LIMITED, Beijing (CN)

(72) Inventor: Lianhai Wu, Beijing (CN)

(21) Appl. No.: 18/730,951

(22) PCT Filed: Jan. 27, 2022
(86) PCT No.: PCT/CN2022/074436

§ 371 Date: Jul. 22, 2024

(51) Int. Cl. H04W 76/20; H04W 36/00; H04W 76/19; H04W 76/38; H04W 92/18

(52) U.S. Cl. CPC H04W 76/20; H04W 36/03; H04W 76/19; H04W 76/38; H04W 92/18

(57) ABSTRACT

Embodiments of the present application relate to methods and apparatuses of conditions and behaviours associated with some timers in a layer-2 (L2) UE-to-Network (U2N) relay case. According to an embodiment of the present application, a user equipment (UE) includes a processor and a transceiver coupled to the processor; and the processor is configured: to access a serving cell via a relay UE; and to receive, via the transceiver from the serving cell, configuration information associated with at least one of: a timer associated with radio resource control (RRC) setup request; a timer associated with RRC reestablishment request; a timer associated with RRC resume request; or a timer associated with reception of RRC release or RRC reject. In response to at least one timer is started, the UE shall stop the timer based on relay related conditions.

### TECHNICAL FIELD

Embodiments of the present application generally relate to wireless communication technology, in particular to methods and apparatuses of conditions and behaviours associated with some timers in a layer-2 (L2) UE-to-Network (U2N) relay case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system. A U2N relay UE is a UE that provides functionality to support connectivity to the network for U2N remote UE(s).

Currently, in a 3GPP 5G system or the like, details regarding conditions and behaviours associated with some timers in a L2 U2N relay case have not been specifically discussed yet.

### SUMMARY

Some embodiments of the present application provide a user equipment (UE). The UE includes a processor and a transceiver coupled to the processor; and the processor is configured: to access a serving cell via a relay UE; and to receive, via the transceiver from the serving cell, configuration information associated with at least one of: a timer associated with radio resource control (RRC) setup request; a timer associated with RRC reestablishment request; a timer associated with RRC resume request; or a timer associated with reception of RRC release or RRC reject.

In some embodiments, the processor of the UE is configured to start the timer associated with RRC setup request, in response to transmitting a RRC setup request message.

In some embodiments, the processor of the UE is configured to stop the timer associated with RRC setup request, in response to fulfilling at least one of: upon receiving, from the relay UE, a first notification associated with at least one of: the relay UE handover, a radio link failure (RLF) on a Uu link of the relay UE, or a cell reselection of the relay UE; upon declaring a sidelink RLF on a link between the UE and the relay UE; upon determining that the relay UE becomes unsuitable; or upon a relay selection or relay reselection; upon determining that the selected relay UE or reselected relay UE becomes unsuitable.

In some embodiments, in response to an expiry of the timer associated with RRC setup request, the processor of the UE is configured to transmit, to an upper layer of the UE, information indicating at least one of: a failure to establish a RRC connection; a sidelink RLF on a link between the UE and the relay UE; a RLF on a Uu link of the relay UE; a reception of a notification of the relay UE handover; the UE determining that the relay UE becomes unsuitable; a relay selection or relay reselection; or the UE determining that the selected relay UE or reselected relay UE becomes unsuitable.

In some embodiments, the processor of the UE is configured to start the timer associated with RRC reestablishment request, in response to transmitting a RRC reestablishment request message.

In some embodiments, the processor of the UE is configured to stop the timer associated with RRC reestablishment request, in response to fulfilling at least one of: upon receiving, from the relay UE, a first notification associated with at least one of: the relay UE handover, a radio link failure (RLF) on a Uu link of the relay UE, or a cell reselection of the relay UE; upon declaring a sidelink RLF on a link between the UE and the relay UE; the UE determining that the relay UE becomes unsuitable; upon a relay selection or relay reselection; or the UE determining that the selected relay UE or reselected relay UE becomes unsuitable.

In some embodiments, the processor of the UE is configured to determine that the relay UE becomes unsuitable or determine that the selected relay UE or reselected relay UE becomes unsuitable, in response to at least one of: receiving the first notification from the relay UE; receiving, from the relay UE, a second notification associated with at least one of: a handover failure of the relay UE, or a recovery failure on the Uu link of the relay UE; declaring the sidelink RLF on the link between the UE and the relay UE; a channel quality of the link between the UE and the relay UE being less than a first threshold; declaring a sidelink RLF on a link between the UE and the selected relay UE or reselected relay UE; or a channel quality of the link between the UE and the selected relay UE or reselected relay UE being less than a second threshold.

In some embodiments, the processor of the UE is configured to start the timer associated with RRC resume request, in response to transmitting a RRC resume request message.

In some embodiments, the processor of the UE is configured: to continue at least one of: a relay selection or relay reselection related measurement, or a relay selection or relay reselection related evaluation; and to perform a relay selection or relay reselection, in response to a condition for the relay selection or relay reselection being fulfilled.

In some embodiments, the processor of the UE is configured to stop the timer associated with RRC resume request, in response to fulfilling at least one of: upon receiving, from the relay UE, a first notification associated with at least one of: the relay UE handover, a radio link failure (RLF) on a Uu link of the relay UE, or a cell reselection of the relay UE; upon receiving, from the relay UE, a second notification associated with at least one of: a handover failure of the relay UE, or a recovery failure on the Uu link of the relay UE; or upon declaring a sidelink RLF on a link between the UE and the relay UE.

In some embodiments, the processor of the UE is configured to enter a RRC idle state, in response to the timer associated with RRC resume request being running and in response to: a second serving cell of the selected relay UE or reselected relay UE being different from the serving cell of the UE upon a relay selection or relay reselection; or receiving, from the relay UE, a notification associated with at least one of: the relay UE handover, a radio link failure (RLF) on a Uu link of the relay UE, or a cell reselection of the relay UE.

In some embodiments, the processor of the UE is configured to start the timer associated with reception of RRC release or RRC reject, in response to transmitting a RRC resume request message.

In some embodiments, the processor of the UE is configured to stop the timer associated with reception of RRC release or RRC reject, in response to fulfilling at least one of: upon a relay selection or relay reselection; a second serving cell of the selected relay UE or reselected relay UE being different from the serving cell of the UE; or upon receiving, from the relay UE, a notification associated with at least one of: the relay UE handover, a radio link failure (RLF) on a Uu link of the relay UE, or a cell reselection of the relay UE.

In some embodiments, the processor of the UE is configured to enter a RRC idle state, in response to the timer associated with reception of RRC release or RRC reject being running and in response to: a second serving cell of the selected relay UE or reselected relay UE being different from the serving cell of the UE upon a relay selection or relay reselection; or receiving, from the relay UE, a notification associated with at least one of: the relay UE handover, a radio link failure (RLF) on a Uu link of the relay UE, or a cell reselection of the relay UE.

Some embodiments of the present application provide a relay UE. The relay UE includes a processor and a transceiver coupled to the processor; and the processor is configured: to access a serving cell, wherein a remote UE communicates with the serving cell via the relay UE; and to receive, via the transceiver from the serving cell, configuration information associated with at least one of: a timer associated with radio resource control (RRC) setup request; a timer associated with RRC reestablishment request; a timer associated with RRC resume request; or a timer associated with reception of RRC release or RRC reject.

In some embodiments, the processor of the relay UE is configured: to receive, via the transceiver from the serving cell, a channel quality threshold value of a link between the UE and the relay UE; and to transmit the channel quality threshold value via the transceiver to the UE.

In some embodiments, the processor of the relay UE is configured to transmit, via the transceiver to the UE, a first notification associated with at least one of: the relay UE handover, a radio link failure (RLF) on a Uu link of the relay UE, or a cell reselection of the relay UE.

In some embodiments, the processor of the relay UE is configured to transmit, via the transceiver to the UE, a second notification associated with at least one of: a handover failure of the relay UE, or a recovery failure on the Uu link of the relay UE.

In some embodiments, the processor of the relay UE is configured: to transmit, via the transceiver to the UE, an identifier (ID) of a second serving cell of the selected relay UE or reselected relay UE, in response to the second serving cell being different from the serving cell of the UE upon a relay selection or relay reselection.

Some embodiments of the present application provide a network node (e.g., a BS). The network node includes a processor and a transceiver coupled to the processor; and the processor is configured: to transmit, via the transceiver to a user equipment (UE) via a relay UE, configuration information associated with at least one of: a timer associated with radio resource control (RRC) setup request; a timer associated with RRC reestablishment request; a timer associated with RRC resume request; or a timer associated with reception of RRC release or RRC reject.

In some embodiments, the processor of the network node is configured to transmit, via the transceiver to the UE via the relay UE, a channel quality threshold value of a link between the UE and the relay UE.

Some embodiments of the present application provide a method, which may be performed by a UE. The method includes: accessing a serving cell via a relay UE; and receiving, from the serving cell, configuration information associated with at least one of: a timer associated with radio resource control (RRC) setup request; a timer associated with RRC reestablishment request; a timer associated with RRC resume request; or a timer associated with reception of RRC release or RRC reject.

In some embodiments, the method further comprises starting the timer associated with RRC setup request, in response to transmitting a RRC setup request message.

In some embodiments, the method further comprises stopping the timer associated with RRC setup request, in response to fulfilling at least one of: upon receiving, from the relay UE, a first notification associated with at least one of: the relay UE handover, a radio link failure (RLF) on a Uu link of the relay UE, or a cell reselection of the relay UE; upon declaring a sidelink RLF on a link between the UE and the relay UE; the UE determining that the relay UE becomes unsuitable; upon a relay selection or relay reselection; or the UE determining that the selected relay UE or reselected relay UE becomes unsuitable.

In some embodiments, the method further comprises: in response to an expiry of the timer associated with RRC setup request, transmitting, to an upper layer of the UE, information indicating at least one of: a failure to establish a RRC connection; a sidelink RLF on a link between the UE and the relay UE; a RLF on a Uu link of the relay UE; a reception of a notification of the relay UE handover; the UE determining that the relay UE becomes unsuitable; a relay selection or relay reselection; or the UE determining that the selected relay UE or reselected relay UE becomes unsuitable.

In some embodiments, the method further comprises starting the timer associated with RRC reestablishment request, in response to transmitting a RRC reestablishment request message.

In some embodiments, the method further comprises stopping the timer associated with RRC reestablishment request, in response to fulfilling at least one of: upon receiving, from the relay UE, a first notification associated with at least one of: the relay UE handover, a radio link failure (RLF) on a Uu link of the relay UE, or a cell reselection of the relay UE; upon declaring a sidelink RLF on a link between the UE and the relay UE; upon determining that the relay UE becomes unsuitable; upon a relay selection or relay reselection; or upon determining that the selected relay UE or reselected relay UE becomes unsuitable.

In some embodiments, the method further comprises determining that the relay UE becomes unsuitable or determining that the selected relay UE or reselected relay UE becomes unsuitable, in response to at least one of: receiving the first notification from the relay UE; receiving, from the relay UE, a second notification associated with at least one of: a handover failure of the relay UE, or a recovery failure on the Uu link of the relay UE; declaring the sidelink RLF on the link between the UE and the relay UE; a channel quality of the link between the UE and the relay UE being less than a first threshold; declaring a sidelink RLF on a link between the UE and the selected or reselected relay UE; or a channel quality of the link between the UE and the selected relay UE or reselected relay UE being less than a second threshold.

In some embodiments, the method further comprises starting the timer associated with RRC resume request, in response to transmitting a RRC resume request message.

In some embodiments, the method further comprises continuing at least one of: a relay selection or relay reselection related measurement, or a relay selection or relay reselection related evaluation; and performing a relay selection or relay reselection, in response to a condition for the relay selection or relay reselection being fulfilled.

In some embodiments, the method further comprises stopping the timer associated with RRC resume request, in response to fulfilling at least one of: upon receiving, from the relay UE, a first notification associated with at least one of: the relay UE handover, a radio link failure (RLF) on a Uu link of the relay UE, or a cell reselection of the relay UE; upon receiving, from the relay UE, a second notification associated with at least one of: a handover failure of the relay UE, or a recovery failure on the Uu link of the relay UE; or upon declaring a sidelink RLF on a link between the UE and the relay UE.

In some embodiments, the method further comprises entering a RRC idle state, in response to the timer associated with RRC resume request being running and in response to: a second serving cell of the selected relay UE or reselected relay UE being different from the serving cell of the UE upon a relay selection or relay reselection; or receiving, from the relay UE, a notification associated with at least one of: the relay UE handover, a radio link failure (RLF) on a Uu link of the relay UE, or a cell reselection of the relay UE.

In some embodiments, the method further comprises starting the timer associated with reception of RRC release or RRC reject, in response to transmitting a RRC resume request message.

In some embodiments, the method further comprises stopping the timer associated with reception of RRC release or RRC reject, in response to fulfilling at least one of: upon a relay selection or relay reselection; a second serving cell of the selected relay UE or reselected relay UE being different from the serving cell of the UE; or upon receiving, from the relay UE, a notification associated with at least one of: the relay UE handover, a radio link failure (RLF) on a Uu link of the relay UE, or a cell reselection of the relay UE.

In some embodiments, the method further comprises entering a RRC idle state, in response to the timer associated with reception of RRC release or RRC reject being running and in response to: a second serving cell of the selected relay UE or reselected relay UE being different from the serving cell of the UE upon a relay selection or relay reselection; or receiving, from the relay UE, a notification associated with at least one of: the relay UE handover, a radio link failure (RLF) on a Uu link of the relay UE, or a cell reselection of the relay UE.

Some embodiments of the present application provide a method, which may be performed by a relay UE. The method includes: accessing a serving cell, wherein a remote UE communicates with the serving cell via the relay UE; and receiving, from the serving cell, configuration information associated with at least one of: a timer associated with radio resource control (RRC) setup request; a timer associated with RRC reestablishment request; a timer associated with RRC resume request; or a timer associated with reception of RRC release or RRC reject.

In some embodiments, the method further comprises receiving, from the serving cell, a channel quality threshold value of a link between the UE and the relay UE; and transmitting the channel quality threshold value to the UE.

In some embodiments, the method further comprises transmitting, to the UE, a first notification associated with at least one of: the relay UE handover, a radio link failure (RLF) on a Uu link of the relay UE, or a cell reselection of the relay UE.

In some embodiments, the method further comprises transmitting, to the UE, a second notification associated with at least one of: a handover failure of the relay UE, or a recovery failure on the Uu link of the relay UE.

In some embodiments, the method further comprises transmitting, to the UE, an identifier (ID) of a second serving cell of the selected relay UE or reselected relay UE, in response to the second serving cell being different from the serving cell of the UE upon a relay selection or relay reselection.

Some embodiments of the present application provide a method, which may be performed by a network node (e.g., a BS). The method includes: transmitting, to a user equipment (UE) via a relay UE, configuration information associated with at least one of: a timer associated with radio resource control (RRC) setup request; a timer associated with RRC reestablishment request; a timer associated with RRC resume request; or a timer associated with reception of RRC release or RRC reject.

In some embodiments, the method further comprises transmitting, to the UE via the relay UE, a channel quality threshold value of a link between the UE and the relay UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE, a relay UE, or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a sidelink RRC reconfiguration procedure in accordance with some embodiments of the present application.

FIG. 3 illustrates a flow chart of an exemplary procedure of wireless communications in accordance with some embodiments of the present disclosure.

FIG. 4 illustrates a flow chart of an exemplary procedure of wireless communications in accordance with some embodiments of the present disclosure.

FIGS. 5A and 5B illustrate flow charts of two exemplary procedures of wireless communications in accordance with some embodiments of the present disclosure.

FIGS. 6A and 6B illustrate flow charts of two exemplary procedures of wireless communications in accordance with some embodiments of the present disclosure.

FIG. 7 illustrates an exemplary block diagram of an apparatus for a L2 U2N relay case according to some embodiments of the present application.

FIG. 8 illustrates a further exemplary block diagram of an apparatus for a L2 U2N relay case according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

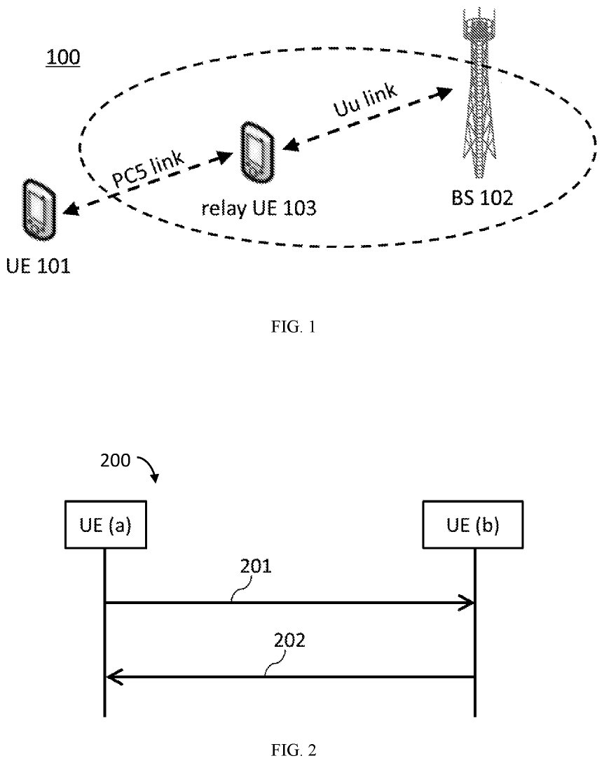

FIG. 1 illustrates a schematic diagram of a wireless communication system 100 in accordance with some embodiments of the present application. As shown in FIG. 1, the wireless communication system 100 includes UE 101, BS 102, and relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link. UE 101 may be a U2N remote UE. Relay UE 103 may be a U2N relay UE, which is a UE that provides functionality to support connectivity to the network for U2N remote UE(s).

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

FIG. 2 illustrates an exemplary flowchart of a sidelink RRC reconfiguration procedure in accordance with some embodiments of the present application. As shown in FIG. 2, in step 201, UE (a) (e.g., UE 101 as illustrated and shown in FIG. 1) initiates a sidelink RRC reconfiguration procedure to UE (b) (e.g., relay UE 102 as illustrated and shown in FIG. 1) by transmitting RRCReconfigurationSidelink message to UE (b).

If the sidelink RRC reconfiguration procedure is successfully completed, in step 202, UE (b) may transmit “a RRC reconfiguration complete sidelink message” to UE (a), e.g., RRCReconfigurationCompleteSidelink message as specified in 3GPP standard documents. Alternatively, if the sidelink RRC reconfiguration procedure is not successfully completed, in step 202, UE (b) may transmit “a RRC reconfiguration failure sidelink message” to UE (a), e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

In accordance with 3GPP standard document TS38.331, timers T300, T301, T302, and T319 are defined as follows:
(1) Regarding timer T300, a trigger condition for starting T300 is “Upon transmission of RRCSetupRequest”. A trigger condition for stopping T300 is “Upon reception of RRCSetup or RRCReject message, cell re-selection, and upon abortion of connection establishment by upper layers”. At expiry of T300, a UE performs the actions as specified in section 5.3.3.7 of TS38.331.
(2) Regarding timer T301, a trigger condition for starting T301 is “Upon transmission of RRCReestablishmentRequest”. A trigger condition for stopping T301 is “Upon reception of RRCReestablishment or RRCSetup message as well as when the selected cell becomes unsuitable”. At expiry of T301, a UE goes to RRC_IDLE state.
(3) Regarding timer T302, a trigger condition for starting T302 is “Upon reception of RRCReject while performing RRC connection establishment or resume, upon reception of RRCRelease with waitTime”. A trigger condition for stopping T302 is “Upon entering RRC_CONNECTED or RRC_IDLE, upon cell re-selection and upon reception of RRCReject message”. At expiry of T302, a UE informs upper layers about barring alleviation as specified in section 5.3.14.4 of TS38.331.
(4) Regarding timer T319, a trigger condition for starting T319 is “Upon transmission of RRCResumeRequest or RRCResumeRequest1”. A trigger condition for stopping T319 is “Upon reception of RRCResume, RRCSetup, RRCRelease, RRCRelease with suspendConfig or RRCReject message, cell re-selection, and upon abortion of connection establishment by upper layers”. At expiry of T319, a UE performs the actions as specified in section 5.3.13.5 of TS38.331.

Embodiments of the present application aim to solve issues in a L2 U2N relay case, including new trigger condition(s) for stopping timer T300, timer T301, timer T302, and/or timer T319 in the L2 U2N relay case. For example, some embodiments of the present application study new cases for cell change when timer T319 or timer T302 is running.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

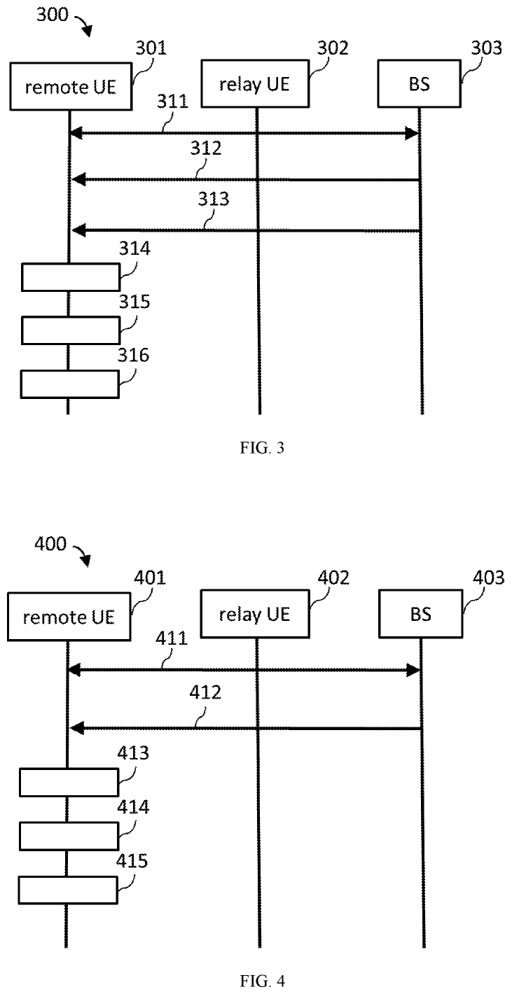

FIG. 3 illustrates a flow chart of an exemplary procedure 300 of wireless communications in accordance with some embodiments of the present disclosure. Details described in all other embodiments of the present disclosure are applicable for the embodiments shown in FIG. 3.

Exemplary procedure 300 refers to a timer associated with RRC Setup Request (which is marked as “timer T1” for simplicity) (e.g., T300). Referring to FIG. 3, remote UE 301, relay UE 302, and BS 303 may function as UE 101, relay UE 103, and BS 102, shown in FIG. 1, respectively. In particular, exemplary procedure 300 includes following steps.

In Step 311, remote UE 301 accesses BS 303 via relay UE 302, e.g., which is a layer-2 UE-to-Network (L2 U2N) relay UE.

In Step 312, remote UE 301 receives configuration(s) including a timer T1 associated with RRC Setup Request (e.g., T300), for example, via RRCReconfiguration message, from BS 303. In some embodiments, the configuration(s) can be broadcasted via SIB1. For example, the configuration(s) includes a timer value of timer T1.

In Step 313, BS 303 transmits RRCRelease message to remote UE 301.

In Step 314, remote UE 301 enters RRC_IDLE state after remote UE 301 receives the RRCRelease message.

In Step 315, remote UE 301 initiates the procedure for RRC connection establishment when upper layer(s) of remote UE 301 requests an establishment of an RRC connection while remote UE 301 is in RRC_IDLE state. In some embodiments, remote UE 301 transmits RRCSetupRequest message. For instance, the RRCSetupRequest message includes an identifier (ID) of remote UE 301 and/or an establishment cause (e.g., mt-Access, mo-Signalling, mo-Data, mo-VoiceCall, and/or mo-VideoCall).

In some embodiments, in Step 315, remote UE 301 has acquired essential system information. In some embodiments, remote UE 301 shall start timer T1 (e.g., T300) when remote UE 301 transmits the RRCSetupRequest message. In some embodiments, remote UE 301 may continue relay (re)selection related measurement(s) and/or relay (re)selection related evaluation(s). In a case that condition(s) for relay (re)selection are fulfilled, remote UE 301 shall perform the relay (re)selection.

In Step 316, there may be following different embodiments in different cases.

In particular, in some embodiments of Step 316, remote UE 301 stops timer T1 (e.g., T300) when at least one of the following conditions is fulfilled:
(1) Upon reception of RRCSetup message or RRCReject message, a cell reselection of relay UE 302, and upon abortion of connection establishment by upper layer(s) of remote UE 301.
(2) Upon receiving, from relay UE 302, a notification associated with at least one of: relay UE 302 handover, a RLF on a Uu link of relay UE 302, or a cell reselection of relay UE 302. For instance, the Uu link is between relay UE 302 and BS 303, e.g., Uu link as shown in FIG. 1.
(3) Upon declaring a sidelink RLF on a link between remote UE 301 and relay UE 302, e.g., PC5 link as shown in FIG. 1.
(4) Upon determining that relay UE 302 becomes unsuitable.
(5) Upon a relay (re)selection.
(6) Upon determining that the (re)selected relay UE (e.g., another relay UE different from relay UE 302) becomes unsuitable.

In some other embodiments of Step 316, once timer T1 (e.g., T300) expires, remote UE 301 informs upper layer(s) information indicating at least one of:
(1) a failure to establish a RRC connection;
(2) a sidelink RLF on a link between remote UE 301 and relay UE 302;
(3) a RLF on a Uu link of relay UE 302;
(4) a reception of a notification of relay UE 302 handover;
(5) remote UE 301 determining that relay UE 302 becomes unsuitable;
(6) a relay (re)selection; or
(7) remote UE 301 determining that the (re)selected relay UE becomes unsuitable.

In some embodiments, remote UE 301 determines that relay UE 302 becomes unsuitable or determines that the (re)selected relay UE (e.g., another relay UE different from relay UE 302) becomes unsuitable, in response to at least one of following events:
(1) receiving, from relay UE 302, a notification associated with at least one of: relay UE 302 handover, a RLF on the Uu link of relay UE 302, or a cell reselection of relay UE 302;
(2) receiving, from relay UE 302, a notification associated with at least one of: a handover failure of relay UE 302, or a recovery failure on the Uu link of relay UE 302;
(3) declaring a sidelink RLF on a link between remote UE 301 and relay UE 302, e.g., PC5 link as shown in FIG. 1;
(4) a channel quality of the link between remote UE 301 and relay UE 302 being less than a threshold;
(5) declaring a sidelink RLF on a link between remote UE 301 and the (re)selected relay UE; or
(6) a channel quality of the link between remote UE 301 and the (re)selected relay UE being less than a threshold.

In some embodiments of the present disclosure, trigger condition(s) for stopping timer T300 may be defined, for example, in a standard document, as “Upon reception of RRCSetup or RRCReject message, cell re-selection, the (re)selected L2 UE-to-Network (U2N) relay UE becomes unsuitable upon abortion of connection establishment by upper layers, upon reception of a notification of relay handover, Uu RLF, and/or cell reselection, upon reception of a notification of relay handover failure and/or Uu recovery failure, upon declaring a sidelink RLF, and upon a channel quality of sidelink being less than one threshold”.

In some embodiments of the present disclosure, the definition of “the (re)selected L2 U2N relay UE becomes unsuitable” include at least one of the following events:
(1) receiving from the relay UE, a notification associated with at least one of: the relay UE handover, a RLF on a Uu link of the relay UE, or a cell reselection of the relay UE;
(2) receiving, from the relay UE, a notification associated with at least one of: a handover failure of the relay UE, or a recovery failure on the Uu link of the relay UE;
(3) declaring the sidelink RLF on a link between the UE and the relay UE;
(4) a channel quality of the link between the UE and the relay UE being less than a threshold;
(5) declaring a sidelink RLF on a link between the UE and the (re)selected relay UE; or
(6) a channel quality of the link between the UE and the (re)selected relay UE being less than a threshold.

It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

FIG. 4 illustrates a flow chart of an exemplary procedure 400 of wireless communications in accordance with some embodiments of the present disclosure. Details described in all other embodiments of the present disclosure are applicable for the embodiments shown in FIG. 4.

Exemplary procedure 400 refers to a timer associated with RRC Reestablishment Request (which is marked as “timer T2” for simplicity) (e.g., T301). Referring to FIG. 4, remote UE 401, relay UE 402, and BS 403 may function as UE 101, relay UE 103, and BS 102, shown in FIG. 1, respectively. In particular, exemplary procedure 400 includes following steps.

In Step 411, remote UE 401 accesses BS 403 via relay UE 402, e.g., which is a L2 U2N relay UE.

In Step 412, remote UE 401 receives configuration(s) including timer T2associated with RRC Reestablishment Request (e.g., T301), for example, via RRCReconfiguration message, from BS 403. In some embodiments, the configuration(s) can be broadcasted via SIB1. For example, the configuration(s) includes a timer value of timer T2.

In Step 413, remote UE 401 at RRC_CONNECTED state initiates a RRC re-establishment procedure when at least one of the following conditions is fulfilled:
(1) remote UE 401 declares a sidelink RLF on a link between remote UE 401 and relay UE 402, e.g., PC5 link as shown in FIG. 1; or
(2) remote UE 401 receives, from relay UE 402, a notification associated with at least one of: relay UE 402 handover, a RLF on a Uu link of relay UE 402, or a cell reselection of relay UE 402. The Uu link of relay UE 402 is between relay UE 402 and BS 403, e.g., Uu link as shown in FIG. 1.

In some embodiments, remote UE 401 shall start timer T311 upon initiation of the RRC re-establishment procedure.

In Step 414, upon selecting a suitable cell or a suitable relay UE, remote UE 401 shall stop timer T311 and transmit RRCReestablishmentRequest message. In some embodiments, remote UE 401 may start timer T2 (e.g., T301) upon transmission of the RRCReestablishmentRequest message.

In Step 415, remote UE 401 stops timer T2 (e.g., T301) when at least one of following conditions is fulfilled.
(1) remote UE 401 receives, from relay UE 402, a notification associated with at least one of: relay UE 402 handover, a RLF on a Uu link of relay UE 402 (which is between relay UE 402 and BS 403, e.g., Uu link as shown in FIG. 1), or a cell reselection of relay UE 402;
(2) remote UE 401 declares a sidelink RLF on a link between remote UE 401 and relay UE 402, e.g., PC5 link as shown in FIG. 1;
(3) remote UE 401 determines that relay UE 402 becomes unsuitable;
(4) upon a relay (re)selection; or
(5) remote UE 401 determines that the (re)selected relay UE (e.g., another relay UE different from relay UE 402) becomes unsuitable.

In some embodiments, remote UE 401 determines that relay UE 402 becomes unsuitable or determines that the (re)selected relay UE (e.g., another relay UE different from relay UE 402) becomes unsuitable, in response to at least one of following events:
(1) receiving, from relay UE 402, a notification associated with at least one of: relay UE 402 handover, a RLF on the Uu link of relay UE 402, or a cell reselection of relay UE 402;
(2) receiving, from relay UE 402, a notification associated with at least one of: a handover failure of relay UE 402, or a recovery failure on the Uu link of relay UE 402;
(3) declaring a sidelink RLF on a link between remote UE 401 and relay UE 402, e.g., PC5 link as shown in FIG. 1;
(4) a channel quality of the link between remote UE 301 and relay UE 302 being less than a threshold;
(5) declaring a sidelink RLF on a link between remote UE 401 and the (re)selected relay UE; or
(6) a channel quality of the link between remote UE 401 and the (re)selected relay UE being less than a threshold.

In some embodiments of the present disclosure, trigger condition(s) for stopping timer T301 may be defined, for example, in a standard document, as “Upon reception of RRCReestablishment message or RRCSetup message as well as when the selected cell becomes unsuitable, or the (re)selected L2 U2N relay UE becomes unsuitable, upon reception of a notification of relay handover, Uu RLF, and/or cell reselection, upon reception of a notification of relay handover failure and/or Uu recovery failure, upon declaring a sidelink RLF, and upon a channel quality of sidelink being less than one threshold.”

In some embodiments of the present disclosure, the definition of “the (re)selected L2 U2N relay UE becomes unsuitable” include at least one of the following events:
(1) receiving from the relay UE, a notification associated with at least one of: the relay UE handover, a RLF on a Uu link of the relay UE, or a cell reselection of the relay UE;
(2) receiving, from the relay UE, a notification associated with at least one of: a handover failure of the relay UE, or a recovery failure on the Uu link of the relay UE;
(3) declaring the sidelink RLF on a link between the UE and the relay UE;
(4) a channel quality of the link between the UE and the relay UE being less than a threshold;
(5) declaring a sidelink RLF on a link between the UE and the (re)selected relay UE; or
(6) a channel quality of the link between the UE and the (re)selected relay UE being less than a threshold.

It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

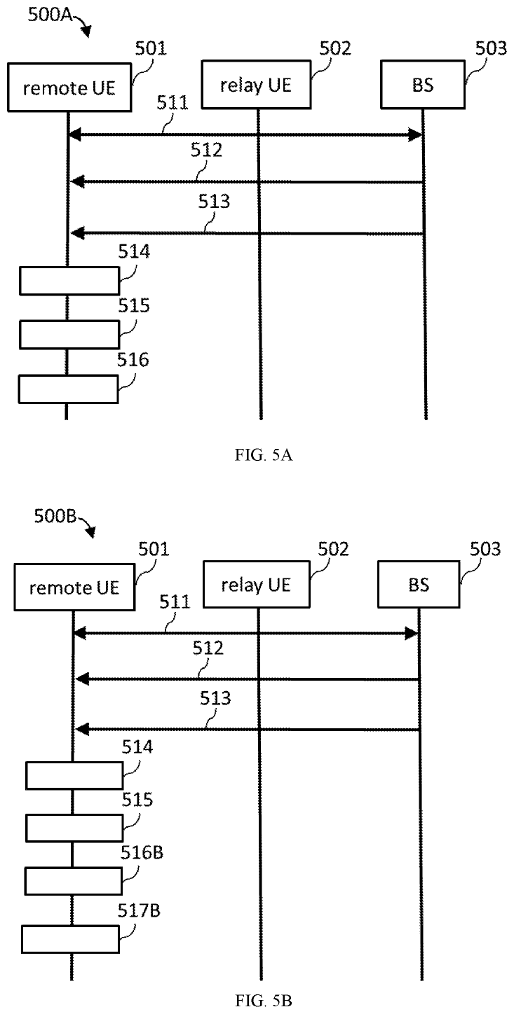

FIGS. 5A and 5B illustrate flow charts of two exemplary procedures 500A and 500B of wireless communications in accordance with some embodiments of the present disclosure. Details described in all other embodiments of the present disclosure are applicable for the embodiments shown in FIGS. 5A and 5B.

Exemplary procedures 500A and 500B refer to a timer associated with RRC Resume Request (which is marked as “timer T3” for simplicity) (e.g., T319). Referring to FIGS. 5A and 5B, remote UE 501, relay UE 502, and BS 503 may function as UE 101, relay UE 103, and BS 102 shown in FIG. 1, respectively.

Steps 511-514 in exemplary procedures 500A and 500B are the same. The difference is that exemplary procedure 500A includes Step 516, whereas exemplary procedure 500B includes Steps 516B and 517B. In particular, the steps in exemplary procedures 500A and 500B are as follows.

In Step 511, remote UE 501 accesses BS 503 via relay UE 502, e.g., which is a L2 U2N relay UE.

In Step 512, remote UE 501 receives configuration(s) including timer T3 associated with RRC Resume Request (e.g., T319), for example, via RRCReconfiguration message, from BS 503. In some embodiments, the configuration(s) can be broadcasted via SIB1. For example, the configuration(s) includes a timer value of timer T3.

In Step 513, BS 503 transmits RRCRelease message with a suspend indication to remote UE 501.

In Step 514, remote UE 501 enters RRC_INACTIVE state after remote UE 501 receives the RRCRelease message.

In Step 515, remote UE 501 initiates the procedure when upper layer(s) of remote UE 501 or access stratum (AS) requests the resume of a suspended RRC connection. In some embodiments, remote UE 501 transmits RRCResumeRequest message or RRCResumeRequest1 message.

In some embodiments, remote UE 501 may start timer T3 (e.g., T319) when remote UE 501 transmits the RRCResumeRequest message. For example, the RRC Resume Request message includes a resume ID and a resume cause (e.g., mo-Data, mo-VoiceCall, mo-VideoCall, mo-SMS, rna-Update, and etc).

In some embodiments, remote UE 501 may continue relay (re)selection related measurement(s) and/or relay (re)selection related evaluation(s). In a case that condition(s) for relay (re)selection are fulfilled, remote UE 501 shall perform the relay (re)selection.

In Step 516 in exemplary procedure 500A, remote UE 501 stops timer T3 (e.g., T319) when at least one of the following conditions is fulfilled.
(1) Upon reception of RRCResume message, RRCSetup message, RRCRelease message, RRCRelease message with suspendConfig.
(2) Upon reception of RRCReject message.
(3) Upon a cell reselection.
(4) Upon a relay (re)selection.
(5) Remote UE 501 receives, from relay UE 502, a notification associated with at least one of: relay UE 502 handover, a RLF on a Uu link of relay UE 502, or a cell reselection of relay UE 502. For instance, the Uu link is between relay UE 502 and BS 503, e.g., Uu link as shown in FIG. 1.
(6) Remote UE 501 receives, from relay UE 502, a notification associated with at least one of: a handover failure of relay UE 502, or a recovery failure on the Uu link of relay UE 502.
(7) Upon declaring a sidelink RLF on a link between the UE and the relay UE

In Step 516B in exemplary procedure 500B, there may be following two options in different embodiments, i.e., Option 1 and Option 2. In some embodiments, remote UE 501 may perform actions upon going to RRC_IDLE state with a release cause “RRC Resume failure” for these options, e.g., in Step 517B.
(1) Option 1: If a relay (re)selection occurs while timer T3 (e.g., T319) is running and the serving cell of the (re)selected relay UE (e.g., another relay UE different from relay UE 502) is different from the current serving cell of remote UE 501, remote UE 501 may enter RRC_IDLE state.
(2) Option 2: If remote UE 501 receives, from relay UE 502, a notification associated with at least one of: relay UE 502 handover, a RLF on a Uu link of relay UE 502, or a cell reselection of from relay UE 502 while timer T3 (e.g., T319) is running, remote UE 501 may enter RRC_IDLE state.

In Step 517B in exemplary procedure 500B, remote UE 501 may perform actions upon going to RRC_IDLE state. In some embodiments, remote UE 501 performs at least one of following actions upon going to RRC_IDLE state. It can be contemplated that remote UE 501 may perform more or less actions in different embodiments.
(1) reset medium access control (MAC);
(2) set the variable pendingRNA-Update to false, if that is set to true. The UE variable VarPendingRNA-Update indicates whether there is a pending radio access network based notification area (RNA) update procedure or not;
(3) stop all timers that are running except T302, T320, T325, T330, T331 and T400;
(4) discard the UE Inactive AS context, if any;
(5) release the suspendConfig, if configured;
(6) remove all the entries within VarConditionalReconfig, if any;
(7) release all radio resources, including release of the radio link control (RLC) entity, the backhaul adaptation protocol (BAP) entity, the MAC configuration and the associated packet data convergence protocol (PDCP) entity and service data adaptation protocol (SDAP) for all established resource blocks (RBs) and backhaul (BH) RLC channels;
(8) indicate the release of the RRC connection to upper layers together with the release cause; or
(9) discard any segments of segmented RRC messages stored.

In some embodiments of the present disclosure, trigger condition(s) for stopping timer T319 may be defined, for example, in a standard document, as “Upon reception of RRCResume, RRCSetup, RRCRelease, RRCRelease with suspendConfig or RRCReject message, upon cell re-selection, upon abortion of connection establishment by upper layers, upon relay (re) selection, upon reception of a notification of relay handover, Uu RLF, and/or cell reselection, upon reception of a notification of relay handover failure and/or Uu recovery failure, and upon declaring a sidelink RLF.”

It should be appreciated by persons skilled in the art that the sequence of the operations in exemplary procedures 500A and 500B in FIG. 5 may be changed and some of the operations in exemplary procedures 500A and 500B in FIG. 5 may be eliminated or modified, without departing from the spirit and scope of the disclosure.

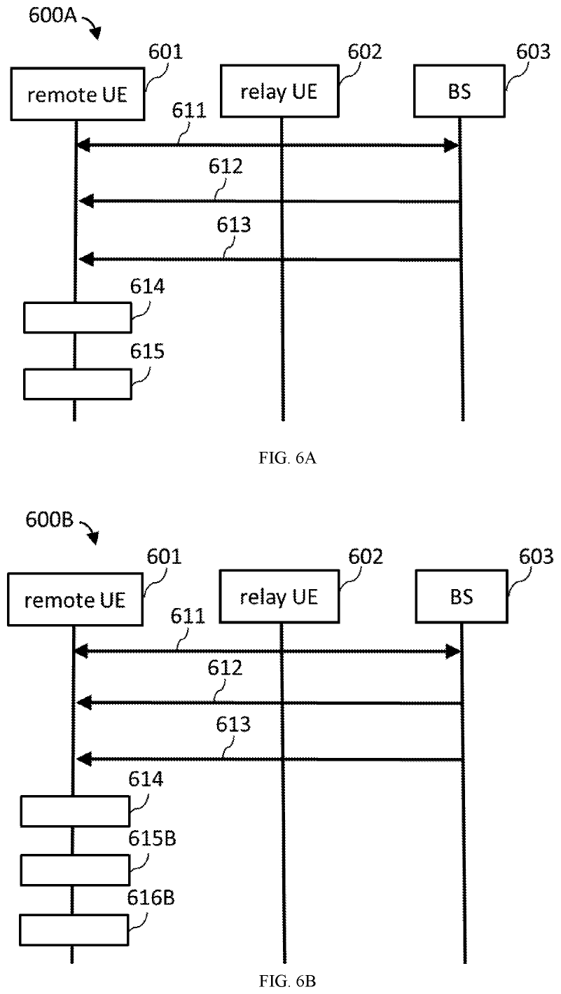

FIGS. 6A and 6B illustrate flow charts of two exemplary procedures 600A and 600B of wireless communications in accordance with some embodiments of the present disclosure. Details described in all other embodiments of the present disclosure are applicable for the embodiments shown in FIGS. 6A and 6B.

Exemplary procedures 600A and 600B refer to a timer associated with reception of RRC Release or RRC reject (which is marked as “timer T4” for simplicity) (e.g., T302). Referring to FIGS. 6A and 6B, remote UE 601, relay UE 602, and BS 603 may function as UE 101, relay UE 103, and BS 102 shown in FIG. 1, respectively.

Steps 611-614 in exemplary procedures 600A and 600B are the same. The difference is that exemplary procedure 600A includes Step 615, whereas exemplary procedure 600B includes Steps 615B and 616B. In particular, the steps in exemplary procedures 600A and 600B are as follows.

In Step 611, remote UE 601 accesses BS 603 via relay UE 602, e.g., which is a L2 U2N relay UE.

In Step 612, remote UE 601 receives the configuration including timer T4 associated with reception of RRC Release or RRC reject (e.g., T302), for example, via RRCReconfiguration message, from BS 603. In some embodiments, the configuration(s) can be broadcasted via SIB1. For example, the configuration(s) includes a timer value of timer T4.

In Step 613, BS 603 transmits RRCReject message or RRCRelease message including waitTime to remote UE 601.

In Step 614, remote UE 601 may start timer T4 (e.g., T302) upon reception of the RRCReject message while performing a RRC connection establishment or resume, upon reception of the RRCRelease message with waitTime.

In Step 615 in exemplary procedure 600A, remote UE 601 stops timer T4 (e.g., T302) when at least one of the following conditions is fulfilled.
(1) Upon entering RRC_CONNECTED state or RRC IDLE state.
(2) Upon a cell re-selection.
(3) Upon reception of RRCReject message.
(4) Upon a relay (re)selection.
(5) A serving cell of the (re)selected relay UE (e.g., another relay UE different from relay UE 602) being different from the serving cell of remote UE 601.
(6) Upon receiving, from relay UE 602, a notification associated with at least one of: relay UE 602 handover, a RLF on a Uu link of relay UE 602, or a cell reselection of relay UE 602. For instance, the Uu link is between relay UE 602 and BS 603, e.g., Uu link as shown in FIG. 1.

In Step 615B in exemplary procedure 600B, there may be following two options in different embodiments, i.e., Option 1 and Option 2. In some embodiments, remote UE 601 may perform actions upon going to RRC_IDLE state with a release cause “RRC Resume failure” for these options, e.g., in Step 616B.
(1) Option 1: If a relay (re)selection occurs while timer T4 (e.g., T302) is running and the serving cell of the (re)selected relay UE (e.g., another relay UE different from relay UE 602) is different from the current serving cell of remote UE 601, remote UE 601 may enter RRC_IDLE state.
(2) Option 2: If remote UE 601 receives, from relay UE 602, a notification associated with at least one of: relay UE 602 handover, a RLF on a Uu link of relay UE 602, or a cell reselection of from relay UE 602 while timer T4 (e.g., T302) is running, remote UE 601 may enter RRC_IDLE state.

In Step 616B in exemplary procedure 600B, remote UE 601 may perform actions upon going to RRC_IDLE state. In some embodiments, remote UE 601 performs at least one of following actions upon going to RRC_IDLE state. It can be contemplated that remote UE 601 may perform more or less actions in different embodiments.
(1) reset MAC;
(2) set the variable pendingRNA-Update to false, if that is set to true. The UE variable VarPendingRNA-Update indicates whether there is a pending RNA update procedure or not;
(3) stop all timers that are running except T302, T320, T325, T330, T331 and T400;
(4) discard the UE Inactive AS context, if any;
(5) release the suspendConfig, if configured;
(6) remove all the entries within VarConditionalReconfig, if any;
(7) release all radio resources, including release of the RLC entity, the BAP entity, the MAC configuration and the associated PDCP entity and SDAP for all established RBs and BH RLC channels;
(8) indicate the release of the RRC connection to upper layers together with the release cause; or
(9) discard any segments of segmented RRC messages stored.

In some embodiments of the present disclosure, trigger condition(s) for stopping timer T302 may be defined, for example, in a standard document, as “Upon entering RRC_CONNECTED or RRC_IDLE state, upon cell re-selection, upon reception of RRCReject message, upon relay (re) selection, upon a (re) selected serving cell being different from a current serving cell, and upon reception of a notification of relay handover, Uu RLF, and/or cell reselection.”

It should be appreciated by persons skilled in the art that the sequence of the operations in exemplary procedures 600A and 600B in FIG. 6 may be changed and some of the operations in exemplary procedures 600A and 600B in FIG. 6 may be eliminated or modified, without departing from the spirit and scope of the disclosure.

Some embodiments of the present application also provide a wireless communication apparatus for a L2 U2N relay case. For example, FIG. 7 illustrates an exemplary block diagram of an apparatus 700 for a L2 U2N relay case according to some embodiments of the present application.

As shown in FIG. 7, the apparatus 700 may include at least one non-transitory computer-readable medium 702, at least one receiving circuitry 701, at least one transmitting circuitry 706, and at least one processor 708 coupled to the non-transitory computer-readable medium 702, the receiving circuitry 704 and the transmitting circuitry 706. The at least one processor 708 may be a CPU, a DSP, a microprocessor etc. The apparatus 700 may be a network apparatus (e.g., a BS) or a UE (e.g., a remote UE or a relay UE) configured to perform a method illustrated in the above or the like.

Although in this figure, elements such as the at least one processor 708, receiving circuitry 704, and transmitting circuitry 706 are described in the singular, the plural is contemplated unless a limitation to the singular is explicitly stated. In some embodiments of the present application, the receiving circuitry 704 and the transmitting circuitry 706 can be combined into a single device, such as a transceiver. In certain embodiments of the present application, the apparatus 700 may further include an input device, a memory, and/or other components.

In some embodiments of the present application, the non-transitory computer-readable medium 702 may have stored thereon computer-executable instructions to cause a processor to implement the method with respect to a remote UE as described above. For example, the computer-executable instructions, when executed, cause the processor 708 interacting with receiving circuitry 704 and transmitting circuitry 706, so as to perform the steps with respect to a remote UE as illustrated above.

In some embodiments of the present application, the non-transitory computer-readable medium 702 may have stored thereon computer-executable instructions to cause a processor to implement the method with respect to a relay UE as described above. For example, the computer-executable instructions, when executed, cause the processor 708 interacting with receiving circuitry 704 and transmitting circuitry 706, so as to perform the steps with respect to a relay UE as illustrated above.

In some embodiments of the present application, the non-transitory computer-readable medium 702 may have stored thereon computer-executable instructions to cause a processor to implement the method with respect to the network apparatus, e.g., a BS, as described above. For example, the computer-executable instructions, when executed, cause the processor 708 interacting with receiving circuitry 704 and transmitting circuitry 706, so as to perform the steps with respect to a network apparatus, e.g., a BS, as depicted above.

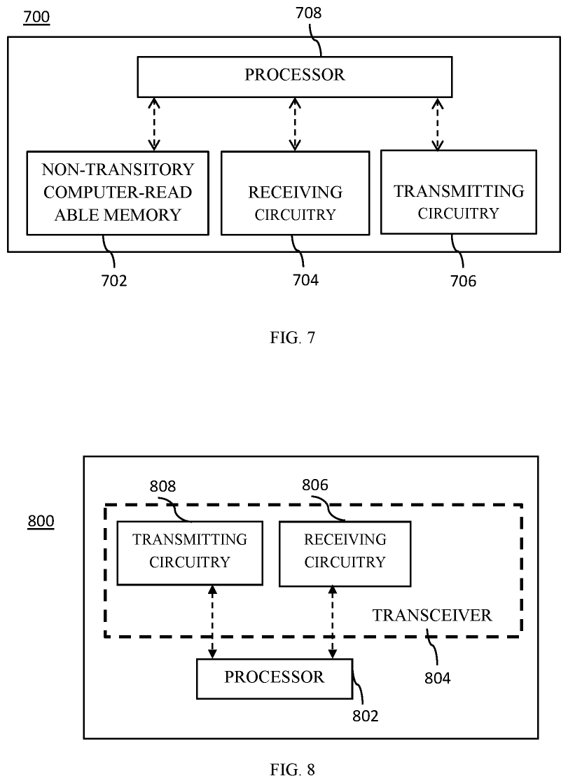

FIG. 8 illustrates a further exemplary block diagram of an apparatus 800 for a L2 U2N relay case according to some embodiments of the present application.

Referring to FIG. 8, the apparatus 800, for example a BS or a UE, may include at least one processor 802 and at least one transceiver 804 coupled to the at least one processor 802. The transceiver 804 may include at least one separate receiving circuitry 806 and transmitting circuitry 808, or at least one integrated receiving circuitry 806 and transmitting circuitry 808. The at least one processor 802 may be a CPU, a DSP, a microprocessor etc.

According to some other embodiments of the present application, when the apparatus 800 is a remote UE, the processor 802 may be configured: to access a serving cell via a relay UE; and to receive, via transceiver 804 from the serving cell, configuration information associated with at least one of: a timer associated with RRC setup request; a timer associated with RRC reestablishment request; a timer associated with RRC resume request; or a timer associated with reception of RRC release or RRC reject.

According to some embodiments of the present application, when the apparatus 800 is a relay UE, the processor 802 is configured: to access a serving cell, wherein a remote UE communicates with the serving cell via the relay UE; and to receive, via transceiver 804 from the serving cell, configuration information associated with at least one of: a timer associated with RRC setup request; a timer associated with RRC reestablishment request; a timer associated with RRC resume request; or a timer associated with reception of RRC release or RRC reject.

According to some embodiments of the present application, when the apparatus 800 is a BS, the processor 802 is configured: to transmit, via transceiver 804 to a UE via a relay UE, configuration information associated with at least one of: a timer associated with RRC setup request; a timer associated with RRC reestablishment request; a timer associated with RRC resume request; or a timer associated with reception of RRC release or RRC reject.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE), comprising:
at least one memory; and
at least one processor coupled with the at least one memory and configured to cause the UE to:
access a serving cell via a relay UE; and
receive, from the serving cell, configuration information associated with at least one of:
a timer associated with radio resource control (RRC) setup request;
a timer associated with RRC reestablishment request;
a timer associated with RRC resume request; or
a timer associated with reception of RRC release or RRC reject.

2. The UE of claim 1, wherein the at least one processor is configured to cause the UE to start the timer associated with RRC setup request, in response to transmitting a RRC setup request message.

3. The UE of claim 2, wherein the at least one processor is configured to cause the UE to stop the timer associated with RRC setup request, in response to fulfilling at least one of:
upon receiving, from the relay UE, a first notification associated with at least one of: relay UE handover, a radio link failure (RLF) on a Uu link of the relay UE, or a cell reselection of the relay UE;
upon declaring a sidelink RLF on a link between the UE and the relay UE;
upon determining that the relay UE becomes unsuitable;
upon a relay selection or relay reselection; or
upon determining that the selected relay UE or reselected relay UE becomes unsuitable.

4. The UE of claim 2, wherein, in response to an expiry of the timer associated with RRC setup request, the at least one processor is configured to cause the UE to transmit, to an upper layer of the UE, information indicating at least one of:
a failure to establish a RRC connection;
a sidelink RLF on a link between the UE and the relay UE;
a RLF on a Uu link of the relay UE;
a reception of a notification of relay UE handover;
the UE determining that the relay UE becomes unsuitable;
a relay selection or relay reselection; or
the UE determining that the selected relay UE or reselected relay UE becomes unsuitable.

5. The UE of claim 1, wherein the at least one processor is configured to cause the UE to start the timer associated with RRC reestablishment request, in response to transmitting a RRC reestablishment request message.

6. The UE of claim 5, wherein the at least one processor is configured to cause the UE to stop the timer associated with RRC reestablishment request, in response to fulfilling at least one of:
upon receiving, from the relay UE, a first notification associated with at least one of: relay UE handover, a radio link failure (RLF) on a Uu link of the relay UE, or a cell reselection of the relay UE;
upon declaring a sidelink RLF on a link between the UE and the relay UE;
the UE determining that the relay UE becomes unsuitable;
upon a relay selection or relay reselection; or
the UE determining that the selected relay UE or reselected relay UE becomes unsuitable.

7. The UE of claim 6, wherein the at least one processor is configured to cause the UE to determine that the relay UE becomes unsuitable or determine that the selected relay UE or reselected relay UE becomes unsuitable, in response to at least one of:
receiving the first notification from the relay UE;
receiving, from the relay UE, a second notification associated with at least one of: a handover failure of the relay UE, or a recovery failure on the Uu link of the relay UE;
declaring the sidelink RLF on the link between the UE and the relay UE;
a channel quality of the link between the UE and the relay UE being less than a first threshold;
declaring a sidelink RLF on a link between the UE and the selected or reselected relay UE; or
a channel quality of the link between the UE and the selected relay UE or reselected relay UE being less than a second threshold.

8. The UE of claim 1, wherein the at least one processor is configured to cause the UE to start the timer associated with RRC resume request, in response to transmitting a RRC resume request message.

9. The UE of claim 8, wherein the at least one processor is configured to cause the UE to:
continue at least one of: a relay selection or relay reselection related measurement, or a relay selection or relay reselection related evaluation; and
perform a relay selection or relay reselection, in response to a condition for the relay selection or relay reselection being fulfilled.

10. The UE of claim 8, wherein the at least one processor is configured to cause the UE to stop the timer associated with RRC resume request, in response to fulfilling at least one of:
upon receiving, from the relay UE, a first notification associated with at least one of: relay UE handover, a radio link failure (RLF) on a Uu link of the relay UE, or a cell reselection of the relay UE;
upon receiving, from the relay UE, a second notification associated with at least one of: a handover failure of the relay UE, or a recovery failure on the Uu link of the relay UE; or
upon declaring a sidelink RLF on a link between the UE and the relay UE.

11. The UE of claim 8, wherein the at least one processor is configured to cause the UE to enter a RRC idle state, in response to the timer associated with RRC resume request being running and in response to:
a second serving cell of the selected relay UE or reselected relay UE being different from the serving cell of the UE; or
receiving, from the relay UE, a notification associated with at least one of: relay UE handover, a radio link failure (RLF) on a Uu link of the relay UE, or a cell reselection of the relay UE.

12. The UE of claim 1, wherein the at least one processor is configured to cause the UE to start the timer associated with reception of RRC release or RRC reject, in response to transmitting a RRC resume request message.

13. The UE of claim 12, wherein the at least one processor is configured to cause the UE to stop the timer associated with reception of RRC release or RRC reject, in response to fulfilling at least one of:
upon a relay selection or relay reselection;
a second serving cell of the selected relay UE or reselected relay UE being different from the serving cell of the UE; or
upon receiving, from the relay UE, a notification associated with at least one of: relay UE handover, a radio link failure (RLF) on a Uu link of the relay UE, or a cell reselection of the relay UE.

14. The UE of claim 12, wherein the at least one processor is configured to cause the UE to enter a RRC idle state, in response to the timer associated with reception of RRC release or RRC reject being running and in response to:
a second serving cell of the selected relay UE or reselected relay UE being different from the serving cell of the UE; or
receiving, from the relay UE, a notification associated with at least one of: relay UE handover, a radio link failure (RLF) on a Uu link of the relay UE, or a cell reselection of the relay UE.

15. An apparatus for performing a network function, the apparatus comprising:
at least one memory; and
at least one processor coupled with the at least one memory and configured to cause the apparatus to:
transmit, to a user equipment (UE) via a relay UE, configuration information associated with at least one of:
a timer associated with radio resource control (RRC) setup request;
a timer associated with RRC reestablishment request;
a timer associated with RRC resume request; or a timer associated with reception of RRC release or RRC reject.

16. A processor for wireless communication, comprising:
at least one controller coupled with at least one memory and configured to cause the processor to:
access a serving cell via a relay user equipment (UE); and
receive, from the serving cell, configuration information associated with at least one of:
a timer associated with radio resource control (RRC) setup request;
a timer associated with RRC reestablishment request;
a timer associated with RRC resume request; or
a timer associated with reception of RRC release or RRC reject.

17. The processor of claim 16, wherein the at least one controller is configured to cause the UE to start the timer associated with RRC setup request, in response to transmitting a RRC setup request message.

18. The processor of claim 17, wherein the at least one controller is configured to cause the UE to stop the timer associated with RRC setup request, in response to fulfilling at least one of:
upon receiving, from the relay UE, a first notification associated with at least one of: relay UE handover, a radio link failure (RLF) on a Uu link of the relay UE, or a cell reselection of the relay UE;
upon declaring a sidelink RLF on a link between the UE and the relay UE;
upon determining that the relay UE becomes unsuitable;
upon a relay selection or relay reselection; or
upon determining that the selected relay UE or reselected relay UE becomes unsuitable.

19. The processor of claim 17, wherein, in response to an expiry of the timer associated with RRC setup request, the at least one controller is configured to cause the processor to transmit, to an upper layer of the UE, information indicating at least one of:
a failure to establish a RRC connection;
a sidelink RLF on a link between the UE and the relay UE;
a RLF on a Uu link of the relay UE;
a reception of a notification of relay UE handover;
the UE determining that the relay UE becomes unsuitable;
a relay selection or relay reselection; or
the UE determining that the selected relay UE or reselected relay UE becomes unsuitable.

20. A method performed by a user equipment (UE), the method comprising:
accessing a serving cell via a relay UE; and
receiving, from the serving cell, configuration information associated with at least one of:
a timer associated with radio resource control (RRC) setup request;
a timer associated with RRC reestablishment request;
a timer associated with RRC resume request; or
a timer associated with reception of RRC release or RRC reject.
